(19) United States
(12) Patent Application Publication
(10) Pub. No.: US 2026/0062321 A1
(43) Pub. Date: Mar. 5, 2026

(54) ELECTROCHEMICAL WATER REMEDIATION TO REMOVE TRACE ORGANICS USING LITHIUM BATTERY CATHODE WASTE

(71) Applicant: UCHICAGO ARGONNE, LLC, Chicago, IL (US)

(72) Inventors: Pietro Papa Lopes, Woodridge, IL (US); Igor Messias, Clarendon Hills, IL (US); Caroline K. Williams, Westmont, IL (US)

(73) Assignee: UCHICAGO ARGONNE, LLC, Chicago, IL (US)

(21) Appl. No.: 19/314,906

(22) Filed: Aug. 29, 2025

Related U.S. Application Data
(60) Provisional application No. 63/689,389, filed on Aug. 30, 2024.

(51) Int. Cl. C02F 1/461; C02F 101/30; H01M 10/54

(52) U.S. Cl. CPC C02F 1/46114; H01M 10/54; C02F 2001/46133; C02F 2001/46142; C02F 2001/46161; C02F 2101/30; C02F 2201/4611; C02F 2201/46185

(57) ABSTRACT

A method for electrochemical remediation of trace organic contaminants from water comprises pumping water containing a trace organic contaminant through an electrochemical cell comprising an anode and a cathode in circuit with a DC power source to apply an electric potential across the electrodes; wherein the anode contacts a catalyst for electrochemically degrading the trace organic contaminant; and the catalyst comprises a transition metal oxide (TMO) from waste lithium battery cathodes. An apparatus suitable for performing the method also is described.

### CROSS-REFERENCE TO RELATED APPLICATIONS

This application claims the benefit of U.S. Provisional Application Ser. No. 63/689,389 filed on Aug. 30, 2024, which is incorporated herein by reference in its entirety.

### STATEMENT OF GOVERNMENT INTEREST

The United States Government has rights in this invention pursuant to Contract No. DE-AC02-06CH11357 between the United States Government and UChicago Argonne, LLC representing Argonne National Laboratory.

### FIELD OF THE INVENTION

This invention relates to water remediation. More particularly, this invention relates to electrochemical water remediation to remove trace organic materials.

### BACKGROUND OF THE INVENTION

Industrial activities, agricultural runoff, and improper waste disposal are significant anthropogenic sources of water pollution. These activities release a variety of pollutants into water bodies, including heavy metals, organic compounds, and pesticides, which can have severe consequences for aquatic ecosystems and human communities that depend on these water sources. Some organic contaminants such as bisphenol A (BPA), and perfluoroalkyl/polyfluoroalkyl substances (PFAS) present potentially high risks due to their high resistance to breakdown, Exposure to these compounds can result in health issues in humans, including immune system suppression, hormonal disruption, kidney and liver damage, and an increased risk of certain cancers. Furthermore, degradation-resistant organic contaminants can persist in water at trace concentrations, making their removal particularly challenging and necessitating the development of highly effective water remediation technologies.

Water remediation technologies have been developed to remove resistant pollutants and other trace organic pollutants from drinking water and wastewater. Electrochemical approaches offer several advantages, including high efficiency, and selectivity towards specific contaminants. One of these approaches is referred to as electrochemical advanced oxidation processes (EAOP), which involve the generation of highly reactive oxidizing species, such as hydroxyl radicals (OH) and others, directly at the surface of electrodes. The oxidative degradation mechanism involves, for example, the attack of hydroxyl radicals on the chemical bonds present in the pollutants, leading to the formation of smaller and less harmful byproducts. Electrocatalysts play an important role in this process, and certain electrode materials like boron-doped diamond (BDD) have demonstrated efficiency in generating reactive oxygen species (ROS). Other examples of electrode materials that have been used include carbon-based materials, such as activated carbon and conductive polymers, which also exhibit ROS generation capabilities.

While EAOP have shown great promise in water remediation, there can be challenges or limitations that may affect their effectiveness or broad applicability. Electrocatalyst cost is a critical bottleneck for use of these technologies. Some advanced materials, such as BDD, precious metals, or carbon nanotubes, have shown effectiveness in contaminant removal but their cost can significantly impact the overall feasibility and practicality of implementing such systems. Furthermore, the stability of electrode materials is crucial for practical applications. If electrode materials degrade quickly, this can also impact the operational cost. For example, production of reactive oxygen species may accelerate the dissolution of the electrode surface, releasing metal ions in solution.

In summary, the activity and stability of the electrocatalysts play a vital role in determining the practicality of electrochemical water remediation technologies. Thus, there is an ongoing need for cost-effective electrode materials that can improve the economic feasibility of electrochemical water remediation technologies and drive these processes to a more competitive and practical position for trace organic removal.

The methods and apparatus described herein address this ongoing need.

### SUMMARY OF THE INVENTION

A method for electrochemical remediation of trace organic contaminants from water comprises pumping a water source containing a trace organic contaminant through an electrochemical cell comprising an anode and a cathode in circuit with a DC power source; wherein the anode contacts a catalyst for electrochemically degrading the trace organic contaminant; and the catalyst comprises a transition metal oxide (TMO) from waste lithium battery cathodes.

A method for electrochemical remediation of trace organic contaminants from water comprises:
(a) providing at least one electrochemical cell comprising a porous anode, a porous cathode, a porous separator between the anode and the cathode, and catalyst particles (e.g., as an aqueous slurry or suspension) comprising a TMO from waste lithium battery cathodes contacting the anode;
(b) pumping water containing an organic contaminant and optionally, an electrolyte salt, through the cell in the following order: the catalyst particles, the anode, the membrane, and the cathode of the electrochemical cell, while applying an electric potential across the anode and cathode;
(c) collecting purified water exiting the cell at the cathode thereof; and
(d) optionally recycling the purified water collected at the cathode back through the cell according to steps (b) and (c) until the concentration of organic contaminant in the water falls below a selected target concentration. In addition, the process of oxidizing the organic contaminant leads to solubilization of transition metal ions from the catalyst, which are subsequently reduced to their metallic state at the cathode of the electrochemical cell, forming a deposit of metallic TM on the cathode. The transition metal deposited on the cathode can be recovered either electrochemically or by standard chemical separation methods. In some embodiments of the methods described herein, multiple electrochemical cells are provided in step (a), and are connected together in series, in parallel, or in both series and parallel, such that the contaminated water is pumped through the connected cells as in steps (b) through (d).

Also described herein is an apparatus for electrochemical remediation of trace organic contaminants from water. The apparatus comprises at least one electrochemical cell comprising a porous anode, a porous cathode, and a porous separator between the porous anode and the porous cathode. The cell typically is enclosed within a housing adapted and arranged so that water can sequentially flow through porous anode, the porous membrane, and the porous cathode and then out of the apparatus. A catalyst chamber is positioned within the housing and is in fluid communication with the porous anode. The chamber is adapted and arranged to retain particles of the catalyst in contact with the porous anode. A water inlet is in fluid communication with the catalyst chamber; and a water outlet is in fluid communication with the porous cathode, so that water can pass into, through, and out of the apparatus. In some embodiments of the apparatus described herein, the apparatus comprises multiple electrochemical cells that are connected together in series, in parallel, or in both series and parallel, such that the contaminated water can be pumped through all of the connected cells.

In use, an electric potential is applied across the anode and the cathode of the electrochemical cell, and contaminated water comprising an organic contaminant is pumped through the water inlet and passes through the catalyst, the anode, the separator, and the cathode, and exits the apparatus through the water outlet. Organic contaminants in the contaminated water are oxidized at the anode in the presence of the catalyst, thereby depleting the concentration of the organic contaminant in the water. Simultaneously, transition metal ions from the TMO catalyst are solubilized, and the solubilized transition metal ions are reduced to their metallic state at the cathode. Transition metals deposited on the cathode can be recovered, thus offsetting at least some of the cost of the water remediation.

In some embodiments, the catalyst comprises particles of black mass from lithium battery recycling. The black mass comprises the TMO which catalyzes the electrochemical degradation of the organic contaminant. As used herein, the term “black mass” refers to a particulate material comprising spent electrode materials recovered from lithium battery recycling processes. Black mass comprises, among other things, at least the cathode active coating (mainly metal oxides, carbon and binder) from waste lithium batteries. Black mass typically includes the electrode coatings of both the cathode, as described above, and the anode (mainly carbon, lithium and binder). Commonly, black mass from lithium battery recycling includes transition metal oxides (e.g., oxides of cobalt, nickel, manganese, and other valuable metals from the cathodes), lithium from the cathodes and anodes, carbon from the anodes and cathodes, metals from the current collectors, and various inactive materials, such as binder materials. The composition of black mass can vary significantly based on the type of lithium-ion battery from which it is recovered. Black mass is an intermediate product from lithium battery recycling, and typically is processed as a raw material for recovering valuable metals. Black mass utilized in the methods and apparatus described herein can be selected based on the type, composition, and quantity of the TMO present in the material, as well as the organic contaminant to be remediated, as the choice of the TMO material can be optimized for particular organic pollutant materials.

Due to the increasing demand for batteries worldwide, recycling waste lithium batteries to recover metal components (Li, Co, Ni) is increasing becoming more important, since many battery metal components are valuable and limited resources. The integration of battery recycling with electrochemical water remediation provides many advantages for both processes. Firstly, the utilization of the spent cathode materials as an electrocatalyst for pollutant oxidation doesn't require any elaborate preparation for the anode, which would impact the operational cost. After use as an organic contaminant oxidation catalyst, the TMO (e.g., on its own, or as black mass) can be further processed in standard battery recycling systems to recover either purified components of the black mass, or to recover the metals present in the remaining TMO and other components of the black mass. Secondly, solubilization and corrosion of the catalyst is not a problem in the process described herein, as it can be in other electrochemical remediation processes, since the catalyst is a waste produce, and solubilized transition metal ions from the catalyst, such as Co, which deposit on the cathode, ultimately requires can be recovered to offset some of the cost of the remediation. The integrated system described herein can be tailored to increase TM recovery, enhance organic pollutant degradation, or even apply conditions that favor both cycles simultaneously, providing a versatile and efficient solution for sustainable environmental remediation.

The following non-limiting embodiments are provided to illustrate certain aspects and features of the methods described herein.
Embodiment 1 is a method for electrochemical remediation of trace organic contaminants from water comprising the steps of:
(a) providing at least one electrochemical cell comprising a porous anode, a porous cathode, a porous separator between the anode and the cathode, and particles of a catalyst comprising a TMO from waste lithium battery cathodes contacting the anode;
(b) pumping water containing an organic contaminant, in order, through the catalyst, the anode, the separator, and the cathode of while applying an electric potential across the anode and cathode;
(c) collecting purified water exiting the cell at the cathode thereof; and
(d) optionally recycling the purified water collected at the cathode back through the cell according to steps (b) and (c) until the concentration of organic contaminant in the water falls below a selected target concentration.
Embodiment 2 is the method of embodiment 1, wherein the metal oxide comprises a material of formula LiₙMO₂, wherein 0≤n≤1.2, and M comprises at least one transition metal selected from the group consisting of Ni, Mn, and Co.
Embodiment 3 is the method of embodiment 2, wherein M comprises Co.
Embodiment 4 is the method of embodiment 2, wherein M comprises a combination of Ni and Co.
Embodiment 5 is the method of embodiment 2, wherein M comprises a combination of Mn and Co.
Embodiment 6 is the method of embodiment 2, wherein M comprises a combination of Ni and Mn.
Embodiment 7 is the method of embodiment 2, wherein M comprises a combination of Al and Co.
Embodiment 8 is the method of embodiment 2, wherein M comprises a combination of Al, Ni, Mn, and Co.
Embodiment 9 is the method of any one of embodiments 1 through 8, wherein the metal oxide is present as a component of lithium battery recycling black mass.
Embodiment 10 is the method of any one of embodiments 1 through 9, further comprising recovering transition metals deposited on the cathode of the electrochemical cell.
Embodiment 11 is the method of any one of embodiments 1 through 10, wherein metallic transition metals are recovered from the cathode.
Embodiment 12 is the method of any one of embodiments 1 through 11, wherein multiple electrochemical cells that are connected together in series, in parallel, or in both series and parallel are provided in step (a), and the contaminated water is pumped through the so-connected cells as in steps (b) through (d).
Embodiment 13 is an apparatus for electrochemical remediation of trace organic contaminants from water comprising:
at least one electrochemical cell comprising a porous anode, a porous cathode, and a porous separator between the porous anode and the porous cathode;
a catalyst chamber in fluid communication with the porous anode; the chamber being adapted and arranged to retain catalyst particles comprising a TMO from waste lithium battery cathodes in contact with the porous anode;
a contaminated water inlet in fluid communication with the chamber; and
a purified water outlet in fluid communication with the porous anode;
the electrochemical cell and the catalyst chamber being enclosed within a housing adapted and arranged so that water can be pumped through the water inlet to sequentially flow through the catalyst chamber, the porous anode, the porous separator, the porous cathode, and the water outlet;
wherein in use, the an electric potential is applied across anode and the cathode; contaminated water comprising a trace organic contaminant is pumped to through the water inlet to flow sequentially through the catalyst chamber, the anode, the separator, the cathode, and the water outlet; the organic contaminants in the contaminated water are oxidized at the anode in the presence of the catalyst, thus depleting the concentration of the organic contaminant in the water; and simultaneously, transition metal ions from the TMO are solubilized, and the solubilized transition metal ions are reduced to the metallic state at the cathode.
Embodiment 14 is the apparatus of embodiment 13, wherein the catalyst chamber comprises a catalyst charging port comprising a first valve and a catalyst discharge port comprising a second valve; wherein the first valve and second valve are together adapted and arranged to allow spent catalyst particles to be removed from the catalyst chamber, and fresh catalyst particles to be introduced into and retained in the catalyst chamber.
Embodiment 15 is the apparatus of embodiment 13 or embodiment 14, wherein the catalyst chamber is filled with the catalyst particles.
Embodiment 16 is the apparatus of any one of embodiments 13 through 15, wherein the metal oxide is present as a component of lithium battery recycling black mass.
Embodiment 17 is the apparatus of any one of embodiments 13 through 16, wherein the TMO comprises a material of formula LiₙMO₂, wherein 0≤n≤1.2, and M comprises at least one transition metal selected from the group consisting of Ni, Mn, and Co.
Embodiment 18 is the apparatus of embodiment 17, wherein M comprises Co.
Embodiment 19 is the apparatus of embodiment 17, wherein M comprises:
   a combination of Co, and Ni,
   a combination of Co and Mn,
   a combination of Ni and Mn,
   a combination of Al and Co, or
   a combination of Al, Co, Ni, and Mn.
Embodiment 20 is the apparatus of any one of embodiments 13 through 19, further comprising a recycling loop adapted and arranged to allow at least a portion of the water exiting the water outlet to recycle back into the catalyst chamber to thereby pass through the catalyst particles and the electrochemical cell one or more additional times until a desired decrease in the concentration of the organic contaminant in the water is achieved.
Embodiment 21 is the apparatus of any one of embodiments 13 through 20, wherein the apparatus comprises multiple electrochemical cells that are connected together in series, in parallel, or in both series and parallel, and in use, such that in use, the contaminated water is pumped through the so-connected cells while an electric potential is applied across the anode and cathode of each cell.

### BRIEF DESCRIPTION OF THE DRAWINGS

The following figures are provided to illustrate certain aspects and features of the methods and apparatus described herein.

FIG. 1 provides a schematic illustration of the electrochemical cycle for degrading an organic contaminant by a transition metal (TM)-containing catalyst.

FIG. 2 provides a schematic illustration of a water remediation apparatus described herein.

FIG. 3 provides a schematic illustration of a water remediation system including a water remediation apparatus as in FIG. 2, along with an additional flow control system for recycling a portion of the purified water back through the apparatus.

FIG. 4 schematically illustrates configurations of a water remediation apparatus that includes multiple electrochemical cells connected together in series (A), in parallel (B), and in both series and parallel (C).

FIG. 5 provides data on BPA degradation in water according to the methods described herein at different electric potentials, at BPA initial concentrations of 20 μM (Panel a), and 1 μM (Panel b) using LiCoO₂-containing catalyst particles.

FIG. 6 provides data on Co dissolution from catalyst particles during BPA degradation in water according to the methods described herein at different electric potentials, at BPA initial concentrations of 20 μM (Panel a), and 1 μM (Panel b) using a LiCoO₂-containing catalyst particles; Panel c provides data on Co deposition on the counter electrode.

FIG. 7 provides bar graphs of PFOS and PFOA degradation after a 12-hour electrolysis run applying a potential ranging from 1.51 up to 2.71 V vs RHE with PFOS and PFOA initial concentration of 5 ppb.

FIG. 8 SEM images of pristine LiCoO₂ cotted onto glassy carbon substrate before (top) after (bottom) being held for one hour held at 2.51V vs RHE.

FIG. 9 shows LiCoO₂ surface after 3 distinct potentials held over 60 min in the presence of 20 μmol L⁻¹ of BPA (top images) and in different BPA concentrations (bottom images).

FIG. 10 shows the percentage of Co removal related to the total mass of Co in the pristine electrode in different conditions. The electrolyte used was 0.1 mol L⁻¹ of Na₂SO₄ pH=6.

### DETAILED DESCRIPTION

Facing the increasing demand for batteries worldwide, recycling waste lithium batteries to recover metal components (Li, Co, Ni) has become important, since they are valuable and limited resources. Based on that, the integration of the battery recycling economy into the electrochemical water remediation addressed many advantages for both processes. The utilization of the spent cathodes as an electrocatalyst for pollutant oxidation doesn't require any special catalyst preparation, thus potentially reducing operational costs. Furthermore, the methods described herein allow for recovery of the transition metal from the catalyst in the same system used for water remediation, since transition metals ions from the catalyst are reduced to their metallic state and deposited at the cathode. The transition metals can be recovered from the cathode either electrochemically or chemically by known methods. This integrated system can be tailored to increase transition metal (TM) recovery, enhance organic pollutant degradation, or both TM recovery and pollutant degradation simultaneously, providing a versatile and efficient solution for sustainable environmental remediation.

Resistant organic pollutants can accumulate in various ecosystems, leading to bioaccumulation. This accumulation poses a risk to both aquatic and terrestrial organisms, potentially causing adverse effects on their reproductive, developmental, and physiological processes. Moreover, these pollutants also contaminate water sources, thereby posing a threat to human health when consumed. Use of electrochemical methods can be considered one of the most beneficial strategies for remediation of water contaminated by organic pollutants, based on several advantages, such as minimal chemical input, the possibility of the system being powered by renewable energy, and selection of variables which allow the system to be tuned for specific reactions and avoid unwanted reactions. However, catalyst cost and energy input costs for electrochemical remediation systems are some of the economic barriers to the large-scale application for water remediation. To overcome this, the methods and apparatus described herein aim to integrate remediation of organic contaminants in water with the recycling of critical Li-ion battery components. Replacement of expensive catalysts for waste battery cathode materials, which can be recovered at the end of the process, renders the electrochemical water treatment more economically competitive.

A method for electrochemical remediation of trace organic contaminants from water comprises pumping water containing a trace organic contaminant through an operating electrochemical cell comprising a porous anode, a porous cathode, and a porous separator between the anode and the cathode. The anode contacts a catalyst for electrochemically degrading the trace organic contaminant. The catalyst is a particulate material comprising a TMO from waste lithium battery cathodes. When an electric potential is applied to the anode and cathode, organic pollutants in the water are oxidized at the anode in the presence of the catalyst particles. At the same time, transition metal ions from the TMO are solubilized and are reduced to their metallic state at the cathode. In addition to oxidizing and degrading organic pollutants/contaminants in the water, the method also provides for recovering the TMs deposited on the cathode, thus offsetting some of the cost of the electrochemical remediation process. In some embodiments, the catalyst particles are black mass particles recovered from a lithium battery recycling process, which can include the TMO in combination with carbon materials, binder materials, and metals from the battery electrode current collectors (e.g., Al and Cu), and other battery component materials.

Anodes for the apparatus and methods described herein can be any conductive porous material that is not itself chemically reactive under the electrochemical conditions used for the water remediation process. Such materials include Ti foam, Ti felt, non-woven Ti mesh, SnOₓ-coated over Ti foam/felt/non-woven mesh, halide-doped SnOₓ coated over Ti foam/felt/non-woven mesh (halide may include F, Cl, Br and I), transition metal doped SnOₓ coated over Ti foam/felt/non-woven mesh (transition metal may include but are not limited to V, Nb, Ta). Cathodes for the apparatus and methods described herein can be any conductive porous material that is not itself chemically reactive under the electrochemical conditions used for the water remediation process. Such materials may include but are not limited to Carbon paper, Carbon fiber, Carbon cloth, Carbon felt, and Carbon non-woven mesh.

An electric potential of up to about 2.51 V (vs. RHE) is applied across the anode and cathode during use to induce the electrochemical degradation of organic contaminants in water. Preferably, the water being treated has a conductivity of about 5 to about 200 millisiemens m⁻¹ (mS m⁻¹) to ensure sufficient current flow during operation of the electrochemical reactor. The conductivity of the water can be enhanced by adding an inert electrolyte salt, such as sodium sulfate, sodium bicarbonate, sodium carbonate, and variations containing various alkali cations such as Li, K, Mg, and Ca to achieve a desired level of conductivity.

The catalyst particles comprise TMO materials recovered from lithium battery recycling processes. The catalyst particles can comprise any lithium transition metal oxide material used in lithium batteries, typically in a discharged (lithiated) or partially discharged state. In some embodiments, the TMO comprises a material of formula LiₙMO₂, wherein 0≤n≤1.2, and M comprises at least one transition metal selected from the group consisting of Ni, Mn, and Co. In addition to a transition metal, M can also comprise other metals, such as Al. Such materials can be lithium deficient (e.g., n<1) or lithium rich materials (e.g., n>1, e.g., 1>n>1.2). In some embodiments, M comprises Co. In other embodiments, M comprises a combination of Co, and Ni, a combination of Co and Mn, a combination of Ni and Mn, a combination of Al and Co, or a combination of Al, Co, Ni, and Mn (materials referred to as NMC cathode materials). Non-limiting examples of TMO materials useful as catalysts for the methods described herein include, but are not limited to, LiₙCoO₂, wherein typically 0<n<1; LiₙNiₓMn_{y}Co_{z}O₂, wherein typically 0<n<1, 0<x<1, 0<y<1, 0<z<1, and x+y+z=1; LiₙNiₓAl_{y}Co_{z}O₂, wherein typically 0<n<1, 0<x<1, 0<y<1, 0<z<1, and x+y+z=1, and the like.

Black mass comprising a TMO cathode material from a lithium battery recycling process can be utilized as the catalyst for the methods and apparatus described herein. As is well known in the art, black mass is a particulate product from lithium battery recycling that typically comprises particles derived from many different lithium battery components in addition to the cathodes, including, without limitation the anodes, the separator, materials from electrolyte residue, and includes various forms of carbon, lithium salts, binder materials, metals from the electrode current collectors, and the like.

The separator component of the apparatus described herein can be any separator used in the lithium battery art. A typical material is a porous polyalkylene material such as microporous polypropylene, microporous polyethylene, a microporous propylene-ethylene copolymer, or a combination thereof, e.g., a separator with layers of different polyalkylenes; a poly(vinylidene-difluoride)-polyacrylonitrile graft copolymer microporous separator; and the like. Examples of suitable separators are described in Arora et al., Chem. Rev. 2004, 104, 4419-4462, which is incorporated herein by reference in its entirety. In addition, the separator can be an ion-selective ceramic membrane such as those described in Nestler et al., AIP Conference Proceedings 1597, 155 (2014), which is incorporated herein by reference in its entirety.

Cathodes for lithium batteries typically are formed by combining a powdered mixture of the cathode active material (typically a TMO) and some form of carbon (e.g., carbon black, graphite, or activated carbon) with a binder such as (polyvinylidene difluoride (PVDF), carboxymethylcellulose, and the like) in a solvent (e.g., N-methylpyrrolidone (NMP) or water) and the resulting mixture is coated on a conductive current collector (e.g., aluminum foil) and dried to remove solvent and form an active layer on the current collector. The anode of a typical lithium battery comprises a material capable of reversibly releasing and accepting lithium during discharging and charging of the electrochemical cell, respectively. Typically, the anode comprises a carbon material such as graphite, graphene, carbon nanotubes, carbon nanofibers, and the like, a silicon-based material such as silicon metal particles, a lead-based material such as metallic lead, a nitride, a silicide, a phosphide, an alloy, an intermetallic compound, a transition metal oxide, and the like. The anode active components typically are mixed with a binder such as (polyvinylidene difluoride (PVDF), carboxymethyl cellulose, and the like) in a solvent (e.g., NMP or water) and the resulting mixture is coated on a conductive current collector (e.g., copper foil) and dried to remove solvent and form an active layer on the current collector. The catalyst particles for the methods and apparatus described herein can include the carbon and binder materials of the cathode, as well as materials from the anode, in addition to the TMO.

Anodes of lithium batteries comprise a material capable of reversibly releasing and accepting lithium during discharging and charging of the electrochemical cell, respectively. Typically, the anode comprises a carbon material such as graphite, graphene, carbon nanotubes, carbon nanofibers, and the like, a silicon-based material such as silicon metal particles, a lead-based material such as metallic lead, a nitride, a silicide, a phosphide, an alloy, an intermetallic compound, a transition metal oxide, and the like. The anode active components typically are mixed with a binder such as (polyvinylidene difluoride (PVDF), carboxymethyl cellulose, and the like) in a solvent (e.g., NMP or water) and the resulting mixture is coated on a conductive current collector (e.g., copper foil) and dried to remove solvent and form an active layer on the current collector. The catalyst particles of the methods and apparatus described herein can include components of the anodes, in addition to the TMO.

The electrodes of lithium batteries utilize binders (e.g., polymeric binders) to aid in adhering cathode active materials to the current collectors. In some cases, the binder comprises a poly(carboxylic acid) or a salt thereof (e.g., a lithium salt), which can be any poly(carboxylic acid), such as poly(acrylic acid) (PAA), poly(methacrylic acid), alginic acid, carboxymethylcellulose (CMC), poly(aspartic acid) (PAsp), poly(glutamic acid) (PGlu), copolymers comprising poly(acrylic acid) chains, poly(4-vinylbenzoic acid) (PV4BA), and the like, which is soluble in the electrode slurry solvent system. The poly(carboxylic acid) can have a Mn, as determined by GPC, in the range of about 1000 to about 450,000 Daltons (preferably about 50,000 to about 450,000 Daltons, e.g., about 130,000 Daltons). In some other embodiments, the binder may comprise anionic materials or neutral materials such as fluorinated polymer such as poly(vinylidene difluoride) (PVDF), carboxymethylcellulose (CMC), and the like. Catalyst particles comprising any of these binder materials may be utilized in the methods and apparatus described herein.

Electrochemical cells and battery designs and configurations, anode and cathode materials, as well as electrolyte salts, solvents and other battery or electrode components (e.g., separator membranes, current collectors), which can be used in the electrolytes, cells and batteries are well known in the secondary battery art, e.g., as described in “Lithium Batteries Science and Technology” Gholam-Abbas Nazri and Gianfranco Pistoia, Eds., Springer Science+Business Media, LLC; New York, NY (2009), which is incorporated herein by reference in its entirety. Black mass recovered from any of these battery designs and configurations may be utilized as catalyst particles in the methods and apparatus described herein.

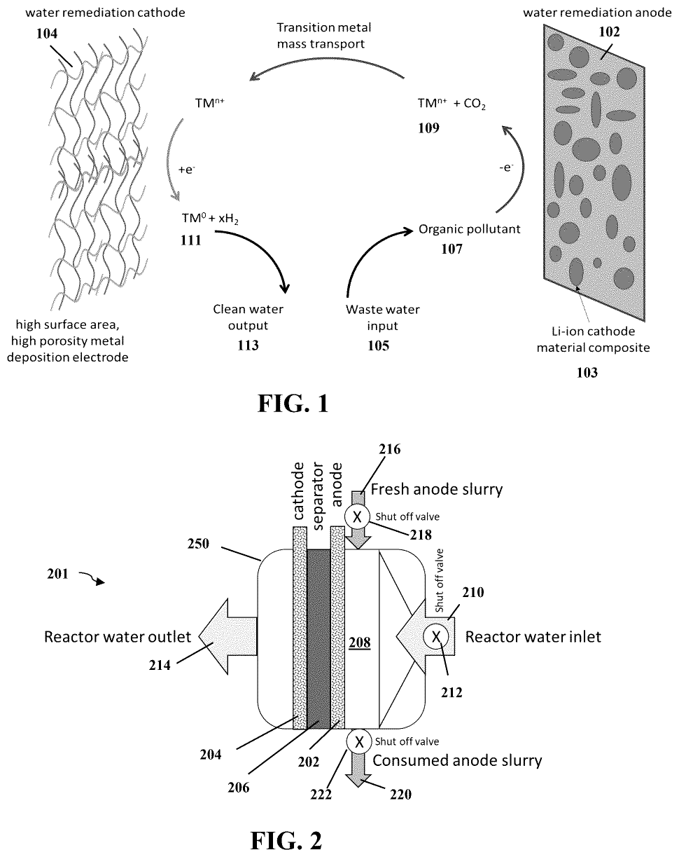

Referring now to the drawings, FIG. 1 schematically illustrates electrochemical oxidation and degradation of an organic pollutant in a contaminated water sample, catalyzed by a transition metal (TM)-containing catalyst according to the method described herein. In FIG. 1, contaminated water (wastewater) 105 comprising an organic contaminant (organic pollutant) 107 contacts anode 102 in the presence of catalyst particles 103 comprising a TMO from lithium battery cathodes. Anode 102 and cathode 104 are connected to a DC power source (not shown) to apply a potential across the electrodes (anode 102 and cathode 104). TM ions (TMⁿ⁺) 109 are solubilized from the catalyst particles 103 and the organic contaminant 107 is degraded, e.g., to carbon dioxide. At cathode 104, the TM ions 109 are reduced to metallic TM (TM⁰), with formation of hydrogen gas, thereby producing purified water (clean water) 113 as an output. Use of Li-ion cathode materials form waste lithium batteries as anodes for advanced electrochemical oxidation is an economical means of purifying water contaminated with organic pollutant materials.

FIG. 2 provides a schematic representation of electrochemical degradation reactor 201, for use in performing the methods described herein. Reactor 201 comprises a porous anode 202, a porous cathode 204, and an inert separator membrane 206 between anode 202 and cathode 204. Catalyst chamber 208 is adjacent to anode 202, and in use, the catalyst chamber 208 is filled with a TMO-containing catalyst, typically as a slurry of catalyst particles in water. Reactor 201 further comprises a water inlet 210 with a valve 212 to control flow of water into the reactor, and a water outlet 214 to collect purified water as it exits the reactor. All of the forgoing components are enclosed within a housing 250. Catalyst chamber 208 is in fluid communication with porous anode 202, and additionally comprises a catalyst charging port 216 comprising a valve 212, and a catalyst discharge port comprising a valve 222. In use, catalyst chamber 208 is filled with catalyst particles comprising a TMO from a lithium battery recycling process, and an electric potential is applied across anode 202 and cathode 204, while water containing an organic contaminant is pumped through inlet 210, and then sequentially flows through catalyst chamber 208, anode 202, separator 206, cathode 204, and purified water flows out of reactor 201 through outlet 214. Organic contaminants in the water are electrochemically degraded at anode 202 in the presence of the catalyst, and TM ions are solubilized from the TMO at anode 202. The TM ions are then reduced at cathode 204 to form a deposit of metallic TM on the cathode. The metallic TM can then re recovered from cathode 204 by conventional separation methods well known in the art.

This system also allows for the use of black mass as the catalyst source, which contains the spent cathode material recovered from battery disassembly processing. After complete removal of the transition metal content in the catalyst, the consumed catalyst is then removed from the electrochemical reactor, and the catalyst chamber is then refilled with fresh catalyst slurry.

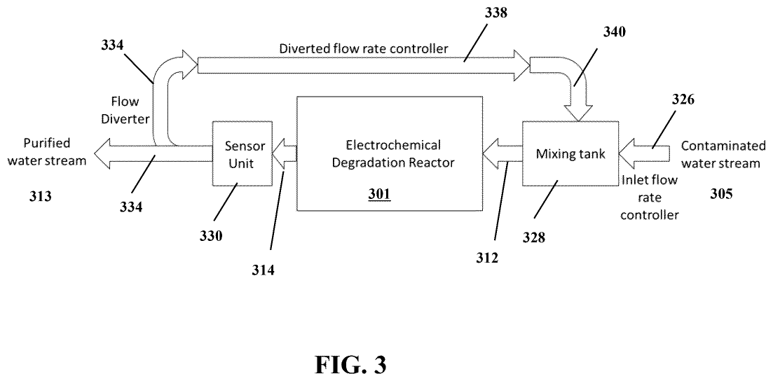

FIG. 3 provides a schematic representation of a water remediation processing system for performing the methods described herein. The water remediation system 300 comprises electrochemical degradation reactor 301 of substantially the same design as reactor 201 of FIG. 2. The system 300 additionally comprises a water inlet flow controller 326 feeding into a mixing tank 328, from which contaminated water 305 lows into reactor 301 via inlet 312. Organic contaminants in contaminated water 305 are electrochemically degraded and purified water 313 exits reactor 301 via outlet 314 and passes through a sensor unit 330 comprising sensors to evaluate the extent of contaminant degradation. After spending a certain dwell time in the reactor, the water is analyzed in sensor unit 330 and either diverted back into the mixing tank 328 through flow diverter 334, which can divert water back to mixing tank 328 via flow rate controller 338 and inlet 340, or can allow the purified water to exit the system in response to measurements from sensor unit 330. Sensor unit 330 can be, but is not limited to, a pH sensor, oxidation-reduction potential (ORP) sensor, F-ion-selective electrode sensor, a conductivity sensor, a refractometry sensor, a UV-Vis-IR spectrometric sensor, and a mass spectrometric sensor.

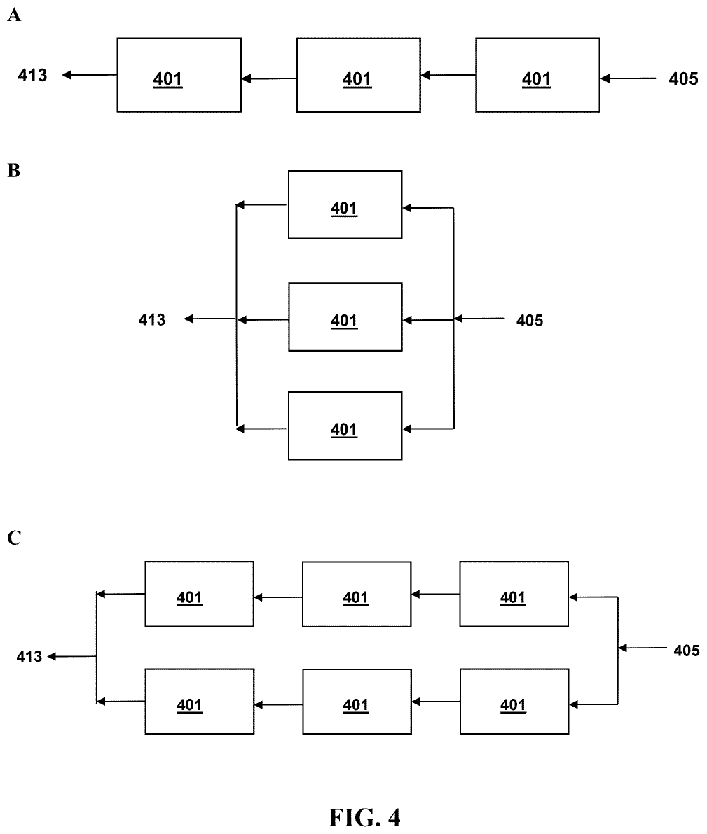

FIG. 4 illustrates different configurations for a water remediation apparatus as described herein comprising multiple electrochemical cells 401 operably connected together in series (Panel A), in parallel (Panel B) and in both series and parallel (Panel C). Contaminated water 405 flows into and through the electrochemical cells 401 in the direction of the arrows, and purified water 413 flows out of the apparatus, during use. Each cell 401 is oriented so that the water flows, in order, through the catalyst particles, the anode, the separator, and the cathode of each individual cell.

The work described herein has demonstrated an integrated electrochemical platform that repurposes spent LiCoO₂ cathodes for the simultaneous degradation of persistent organic pollutants and recovery of critical battery materials. By harnessing the intrinsic catalytic properties of LiCoO₂, the system described herein achieves BPA oxidation, with up to 90% BPA degradation observed at low contaminant initial concentrations in just one hour. Rapid delithiation triggers structural changes in the LCO lattice, leading to the formation of Co⁴⁺ species that controlled cobalt instability. Furthermore, the observed interplay between organic pollutant concentration and metal leaching underscores the versatility of this approach, highlighting its potential for tuning phase transformations to optimize both pollutant degradation and metal recovery. This dual-function strategy not only offers a cost-effective, scalable solution for water treatment but also promotes a circular economy by integrating the recycling of battery materials with environmental cleanup processes.

### Experimental Methods and Results

The effectiveness of the methods described herein was demonstrated for degradation of bisphenol A (BPA) using a LiCoO₂/C/PVDF electrode composition, which is the standard active material for many Li-ion battery cathodes, as the catalyst for the degradation. A slurry of the LiCoO₂/C/PVDF electrode composite was deposited on glassy carbon electrodes to act as the anode/catalyst in an electrochemical degradation cell. The slurry primarily consisted of 90% LiCoO₂, with 5% VULCAN carbon and 5% poly(vinylidene fluoride or poly(vinylidene difluoride) as a conductive additive and a binder, respectively. The solids were dispersed in N-methylpyrrolidone (NMP) and then coated onto the electrodes at a coating level of about 0.70 mg per electrode.

The anode/catalyst composite electrodes were used to demonstrate catalytic degradation of a common organic contaminant in water, BPA, as well as PFOS and PFOA. The electrochemical BPA degradation experiments were performed using 0.1 mol L⁻¹ Na₂SO₄ as electrolyte at pH 6 with 20 μmol L⁻¹ (4.6 mg L⁻¹) of BPA in water. The use of near neutral pH for catalytic removal of pollutants further simplifies processing when the purified water stream is to be returned to the natural environment. The anode/catalyst composite electrodes were paired with a counter electrode to act of the cathode, and the cells were operated at a constant potential for one hour. All the experiments were performed under mass transport control at stirring at 1600 revolutions per minute (rpm). At specific time points, aliquots of the electrolyte were collected and further analyzed using an HPLC to quantify the residual BPA content. The samples were also analyzed by the ICP-MS to evaluate the metal dissolution.

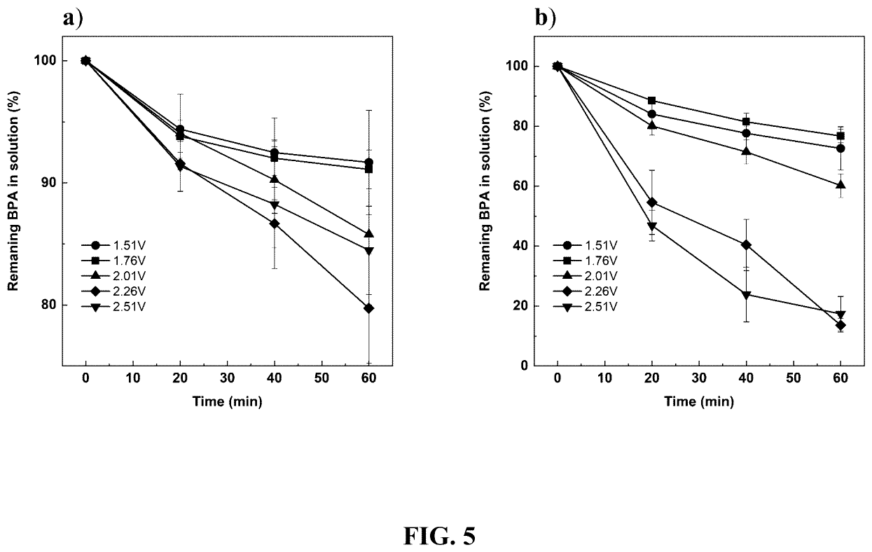

FIG. 5 illustrates BPA removal at different applied potentials from 1.51 V to 2.51 V versus a reversible hydrogen electrode (RHE), indicating that the percentage of remaining BPA reached around 80% within 60 min depending on the potential applied (FIG. 5, Panel a). Current densities ranged from about 0.1 to about 1000 mA cm⁻². This result indicates a relatively efficient and rapid degradation compared with prior work using boron-doped diamond (BDD) as a catalyst (c.f., Shirakashi et al. “Inhibition of perchlorate formation during the electrochemical oxidation of perfluoroalkyl acid in groundwater.” Environmental Science & Technology Letters 6.12 (2019): 775-780; which reported use of BDD to degrade BPA and achieved the complete degradation of the pollutant after 600 min holding the current at 35.7 mA cm⁻²in 0.1 mol L⁻¹ Na₂SO₄ with 20 mg L⁻¹ of BPA).

It is noteworthy that pollutants like BPA are present in the environment in trace concentrations (according to the United States Environmental Protection Agency (EPA) in a range of 0.0009 μg L⁻¹ to 140 μg L⁻¹), which impacts the degradation efficiency due to sluggish kinetics and potential competing reactions. To evaluate the capability of LiCoO₂ catalyst to facilitate electrochemical degradation of BPA under lower concentrations, the same potentials were applied using an initial concentration of 1 μmol L⁻¹ of BPA. FIG. 5, Panel b, shows that within 1 hour under a potential above 2.26V vs RHE, approximately 90 % of the BPA was removed. Thus, LiCoO₂ is an effective catalyst for electrochemical water remediation, even under conditions of trace pollutant concentration.

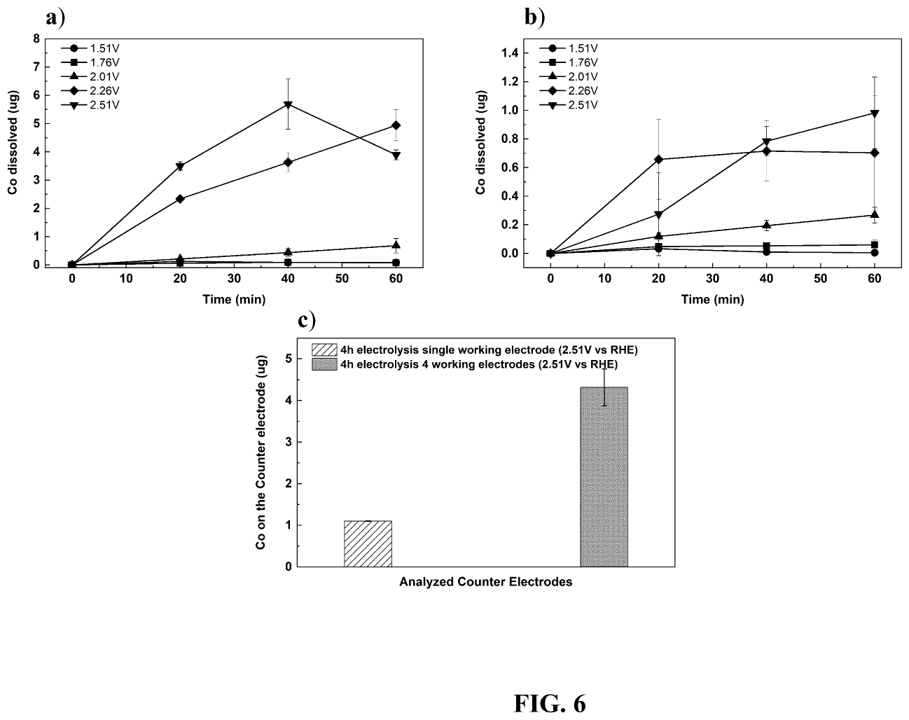

Inductively coupled plasma mass spectrometry (ICP-MS) was used to assess the capability to recover the Co deposited at the cathode, by monitoring the deposition of the cobalt on the counter electrode. The results are shown in FIG. 6. Monitoring the cobalt dissolution (FIG. 5, Panels a and b) using the ICP-MS spectrometer reveals the influence of the applied potential on the metal dissolution in the presence of varying concentration of BPA. The results in FIG. 6, Panels a and b, show that cobalt deposition (and thus also Co dissolution from the TMO) is positively correlated with degradation of the BPA (c.f., FIG. 5). The potential-dependent dissolution rate of Co at high electrode potentials could be attributed to the formation of reactive oxygen species, which plays an important role in organic pollutant degradation.

Holding the working electrode potential at 2.51V vs. RHE for 4 hours on a single working electrode (FIG. 6, Panel c, left bar) or switching the used working electrode for a fresh electrode every hour (FIG. 6, Panel c, right bar) resulted in deposition 1 and 4 μg, respectively, of cobalt on the cathode. This demonstrates the added benefit of recovering transition metals, such as cobalt on the counter electrode (cathode) during the integrated process described herein.

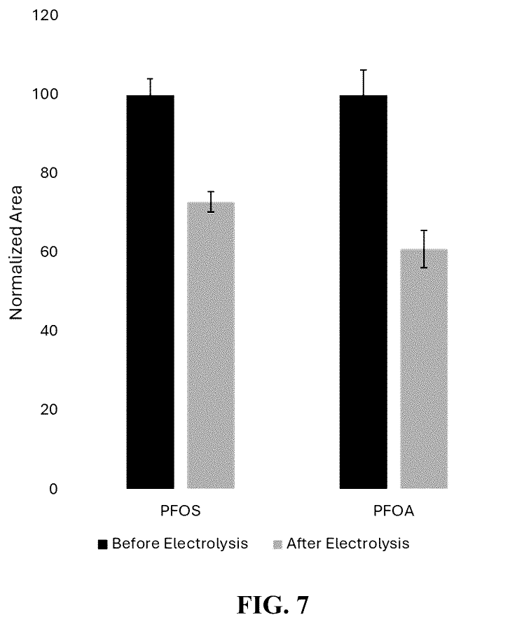

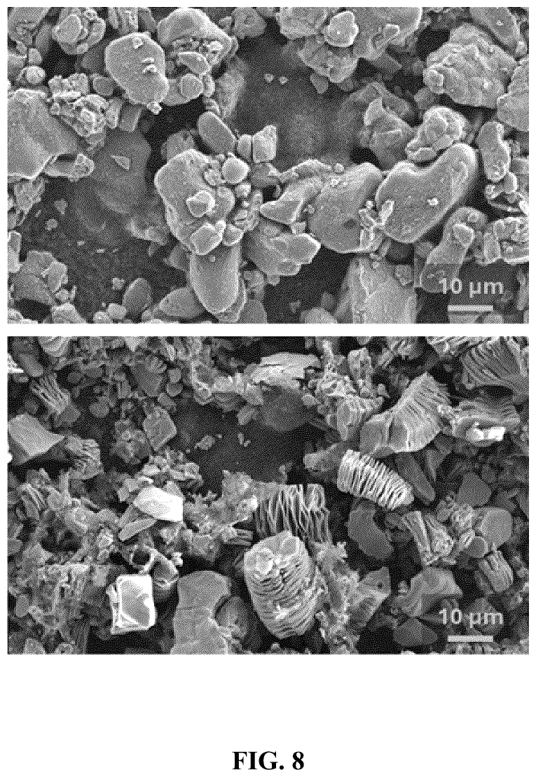

Removal of PFOS and PFOA, which are part of the PFAS-class of molecules, has also been demonstrated using the method and materials (e.g. LiCoO₂/C/PVDF electrode) as described herein and shown in FIG. 7. In a 12-hour run with electrode potentials varying between 1.51 and 2.71V vs RHE can reduce the concentration of a solution containing 5 parts per billion (ppb) of PFOS and PFOA before electrolysis by 27% and 39%, for example.

The dynamic restructuring of catalysts during reactions can be strategically utilized to enhance electrochemical processes, such as reduction and oxidation reactions, as well as facilitating metal extraction and recycling. By altering the composition and structure, the activity, selectivity, and stability of electrocatalysts can be finely tuned. Building on this concept, spent lithium-ion battery cathodes are repurposed for electrochemical water purification. By exploiting the instability of transition metals, critical materials can be recovered, thereby integrating and optimizing two economic cycles. In situ monitoring of lithium and cobalt dissolution during electrochemical process evidenced the dynamic structural evolution of the LCO electrode.

FIG. 8 shows SEM images of pristine LiCoO₂ cotted onto glassy carbon substrate before (top) and after (bottom) holding the potential at 2.51V vs RHE, leading to layered material with higher surface area. To rule out activity from the Vulcan carbon and the binder, a control ink without LiCoO₂ was tested and showed no BPA degradation. In contrast, the presence of LiCoO₂ demonstrated catalytic activity, with differences in performance observed between the two concentrations. At 1 μM, the catalyst presented high degradation of BPA, with approximately 90% of the initial concentration reduced within 1 hour, indicating high activity even at low concentrations. Conversely, at 20 μM, while the catalytic activity remained significant, only about 20% of the initial concentration was degraded within the same timeframe, providing insights into the catalyst's capacity and potential saturation effects at higher concentrations.

Despite the differences in catalytic activity, the current densities measured across various applied potentials remain comparable for different initial concentrations of the organic substrate (FIG. 5). This suggests that a significant portion of the observed current may originate from competing processes beyond the targeted electrooxidation. Specifically, reactions such as the oxygen evolution reaction (OER), reactive oxygen species (ROS) generation, which can indirectly degrade BPA, and electrode corrosion likely contribute to the total current, thereby impacting the overall Faradaic efficiency. To quantitatively resolve these contributions, a rotating ring-disk electrode (RRDE) configuration was utilized. Monitoring The generation of O₂, O₃, and H₂O₂ and deconvoluted their respective formation pathways, were monitored. By tracking these species at overpotentials around 2.51V vs RHE around 40% of the FE was associated with the possible formation of O₃ and SO₅²⁻ while around 17% is associated with H₂O₂. The formation of ROS can be the key for the BPA degradation mechanism.

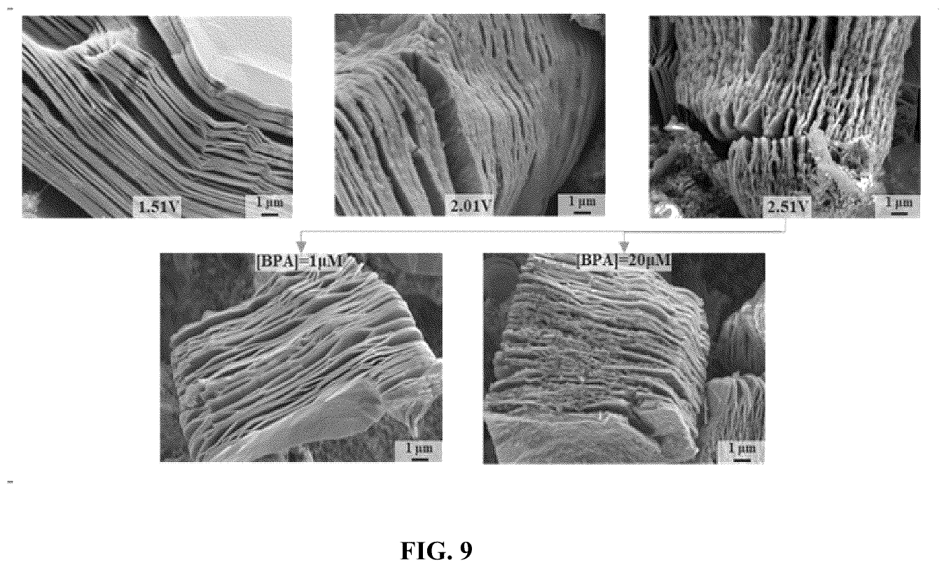

Although the presence of BPA did not markedly alter the intrinsic properties of the electrocatalyst, subtle structural changes were evident upon its degradation. FIG. 9 presents SEM images of the electrocatalyst surface were made after a 1 h applying different potentials in the presence of 20 μmol L⁻¹ BPA (top images) showing formation of spherical/globular deposits within the layered structure, which may correspond to degradation products deposited on the surface, consistent with elevated degradation activity at higher potentials. Moreover, the extent of deposition appears to be contingent on the initial BPA concentration. Images of the catalyst surface after 1 h at 2.51 V vs RHE in different initial BPA concentrations showed no spherical deposits at 1 μmol L⁻¹ BPA, whereas at 20 μmol L⁻¹ BPA, the globular formations were present (FIG. 9, bottom images). This indicates that BPA degradation may follow different mechanisms dependent on the organic initial concentration.

The deposits seen in the BPA experiments likely represent insoluble polymeric degradation products. Specifically, during BPA oxidation under elevated potentials, BPA molecules are oxidized at the cobalt-rich catalytic sites, leading to the generation of BPA-derived radical intermediates. These radicals then undergo coupling reactions to form dimers, trimers, and higher-order oligomers that eventually yield insoluble polymers. The accumulation and deposition of these polymeric species on the catalyst surface manifest as globular nodules. The extent of nodule formation appears to increase with higher applied potential and initial BPA concentration, suggesting that more oxidative potentials and availability of BPA in solution promotes faster polymerization of the intermediates. To evaluate this hypothesis, a flat CoOOH film was electrodeposited onto a glassy carbon substrate and its activity toward BPA degradation was evaluated at the two initial concentrations. Upon applying 2.01 V vs RHE for 10 minutes, a pronounced anodic current decay was observed within the first 30 seconds at the higher BPA concentration, whereas the current remained largely unchanged at 1 μmol L⁻¹, suggesting concentration-dependent electrochemical behavior.

Changes in the local pH at the electrode/electrolyte interface are important to understand trends in dissolution, which are influenced by the accumulation of organic molecules near the surface. Specifically, BPA, which contains hydroxyl groups, can undergo deprotonation due to the anodic potential, leading to local alkalinization. The extraction of protons from the hydroxyl groups increases the concentration of OH⁻ ions in the vicinity of the electrode, thereby raising the local pH.

A more alkaline microenvironment can stabilize Co cations, as the increased negative charge density from deprotonated oxygen species in BPA promotes stronger coordination with Co^{3+/4+}. While the constant anodic potential proved effective for organic degradation, it was relatively inefficient for promoting extensive cobalt dissolution within 1 hour. This limited release is likely associated with the formation of a stable Cobalt phase, in which cobalt attains a +4-oxidation state. This behavior is consistent with previous reports indicating that the onset of lattice oxygen participation and higher-valent cobalt states correlates with enhanced structural robustness.

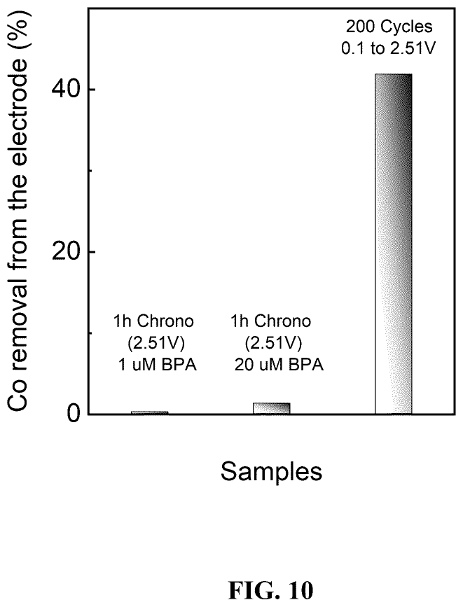

Supported by the in situ dissolution studies of cobalt, a potential-cycling strategy was employed where two potential ranges were tested: between 0.1 and 2.51 V vs RHE and between −0.9 and 2.51 V vs RHE, aimed at repeatedly driving the Co³⁺/Co⁴⁺ redox transition and thereby destabilizing the oxide layer. After 200 cycles, in both conditions ˜130 μg of Co was removed. Despite the changes in the negative potential limit that hasn't affected the total amount dissolved, the loss in activity is more pronounced over the cycles when the electrode is submitted to more cathodic potential. This might be related to a more efficient transition between cobalt Co³⁺/Co⁴⁺. Given the initial cobalt content in the electrode (˜352 μg), at constant potential the maximum cobalt leached amount corresponds to approximately 1.4% of the total mass, while in a dynamic regime approximately 40% of the initial cobalt was leached from the electrode, as quantified by ICP-MS analysis (FIG. 10). This extensive material loss was also evident from morphological changes observed on the electrode surface post-cycling. These findings suggest that dynamic redox modulation, rather than static polarization at positive potentials, is a more effective approach to induce phase transformation and accelerate cobalt dissolution, offering a mechanistic pathway to enhance electrochemical metal recovery.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

The embodiments of the invention in which an exclusive property or privilege is claimed are defined as follows:

1. A method for electrochemical remediation of trace organic contaminants from water comprising the steps of:
(a) providing at least one electrochemical cell comprising a porous anode, a porous cathode, a porous separator between the anode and the cathode, and catalyst particles comprising a transition metal oxide (TMO) from waste lithium battery cathodes contacting the anode;
(b) pumping water containing an organic contaminant and optionally, an electrolyte salt, through the cell in the following order: the catalyst particles, the anode, the membrane, and the cathode of the electrochemical cell; while applying an electric potential difference across the anode and cathode;
(c) collecting purified water exiting the cell at the cathode thereof; and
(d) optionally recycling some or all of the purified water collected at the cathode back through the cell according to steps (b) and (c) until the concentration of organic contaminant in the water falls below a selected target concentration.

2. The method of claim 1, wherein the TMO comprises a material of formula LiₙMO₂, wherein 0≤n≤1.2, and M comprises at least one transition metal selected from the group consisting of Ni, Mn, and Co.

3. The method of claim 2, wherein M comprises Co.

4. The method of claim 2, wherein M comprises a combination of Ni and Co.

5. The method of claim 2, wherein M comprises a combination of Mn and Co.

6. The method of claim 2, wherein M comprises a combination of Ni and Mn.

7. The method of claim 2, wherein M comprises a combination of Al and Co.

8. The method of claim 2, wherein M comprises a combination of Al, Ni, Mn, and Co.

9. The method of claim 2, wherein the TMO is present as a component of black mass from lithium battery recycling.

10. The method of claim 1, wherein the TMO is present as a component of black mass from lithium battery recycling.

11. The method of claim 1, wherein metallic transition metals are recovered from the cathode.

12. The method of claim 1, wherein multiple electrochemical cells that are connected together in series, in parallel, or in both series and parallel are provided in step (a), and the contaminated water is pumped through the so-connected cells as in steps (b) through (d).

13. An apparatus for electrochemical remediation of trace organic contaminants from water comprising:
at least one electrochemical cell comprising a porous anode, a porous cathode, and a porous separator between the porous anode and the porous cathode, the cell being enclosed within a housing adapted and arranged so that water can sequentially flow through porous anode, the porous membrane, and the porous cathode;
a catalyst chamber in fluid communication with the porous anode; the chamber being adapted and arranged to retain catalyst particles comprising a transition metal oxide (TMO) from waste lithium batteries in contact with the porous anode;
a water inlet in fluid communication with the catalyst chamber; and
a water outlet in fluid communication with the porous cathode;
wherein in use, an electric potential is applied across the anode and the cathode; contaminated water comprising an organic contaminant and optionally, an electrolyte salt, is pumped through the water inlet and passes through the catalyst particles, the anode, the separator, and the cathode, and exits the apparatus through the water outlet; organic contaminants in the contaminated water are oxidized at the anode in the presence of the catalyst, thereby depleting the concentration of the organic contaminant in the water; and simultaneously, transition metal ions from the TMO catalyst are solubilized, and the solubilized transition metal ions are reduced to their metallic state at the cathode.

14. The apparatus of claim 13, wherein the catalyst chamber comprises a catalyst charging port comprising a first valve and a catalyst discharge port comprising a second valve; wherein the first valve and second valve are together adapted and arranged to allow a spent catalyst to be discharged from the catalyst chamber and fresh catalyst to be introduced into and retained in the catalyst chamber.

15. The apparatus of claim 13, wherein the catalyst chamber is filled with the catalyst.

16. The apparatus of claim 13, wherein the TMO is present as a component of back mass from lithium battery recycling.

17. The apparatus of claim 16, wherein the TMO comprises a material of formula LiₙMO₂, wherein 0≤n≤1.2, and M comprises at least one transition metal selected from the group consisting of Ni, Mn, and Co.

18. The apparatus of claim 17, wherein M comprises Co.

19. The apparatus of claim 17, wherein M comprises:
a combination of Co, and Ni,
a combination of Co and Mn,
a combination of Ni and Mn,
a combination of Co and Al, or
a combination of Al, Co, Ni, and Mn.

20. The apparatus of claim 13, wherein the TMO comprises a material of formula LiₙMO₂, wherein 0≤n≤1.2, and M comprises at least one transition metal selected from the group consisting of Al, Ni, Mn, and Co.

21. The apparatus of claim 20, wherein M comprises Co.

22. The apparatus of claim 20, wherein M comprises:
a combination of Co, and Ni,
a combination of Co and Mn,
a combination of Ni and Mn,
a combination of Al and Co, or
a combination of Al, Co, Ni, and Mn.

23. The apparatus of claim 13, further comprising a recycling loop adapted and arranged to allow at least a portion of the purified water exiting the water outlet to recycle back into the catalyst chamber to thereby pass through the cell one or more additional times until a desired decrease in the concentration of the organic contaminant is achieved.

24. The apparatus of claim 13, wherein the apparatus comprises multiple electrochemical cells that are connected together in series, in parallel, or in both series and parallel; such that in use, the contaminated water is pumped through the so-connected cells while an electric potential is applied across the anode and cathode of each cell.
